(19) United States
(12) Patent Application Publication
(10) Pub. No.: US 2009/0006381 A1
(43) Pub. Date: Jan. 1, 2009

(54) INFORMATION SEARCH DEVICE, INFORMATION SEARCH METHOD, AND INFORMATION SEARCH PROGRAM

(75) Inventors: Kouji Aoyama, Kawasaki (JP); Noriyuki Kobayashi, Kawasaki (JP); Takanori Ukai, Kawasaki (JP); Jun Arima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/140,808

(22) Filed: Jun. 17, 2008

(30) Foreign Application Priority Data
Jun. 27, 2007 (JP) 2007-169676

(51) Int. Cl. G06F 17/30

(52) U.S. Cl. 707/5; 707/E17.014

(57) ABSTRACT

A systematic problem search unit searches information about a systematic problem that is a common problem to a plurality of projects, using a conditional expression for searching the information about the systematic problem based on one of or a plurality of a count by which the information about the systematic problem is stored in the retrospect storage unit, a count by which a trial improvement plan linked to the systematic problem is stored in the retrospect storage unit, and information indicating whether the stored improvement plan is stored in the retrospect storage unit, as a conditional expression indicating a condition for extracting the information about the systematic problem. a systematic problem output unit outputs a search result in the systematic problem search procedure to each of or one of a predetermined storage unit and a predetermined output unit.

### BACKGROUND OF THE INVENTION

1. Technical Field

The present invention relates to an information search device, an information search method, and an information search program.

2. Description of the Related Art

There is conventionally known a KPT (Keep Problem Try) method as a method of supporting continuous improvements in project-related operation. The KPT method is a method for improving operation in a project by sharing a problem to be solved in the project (Problem), a trial improvement plan that is an improvement plan taken on trial against this problem (Try), and an effective improvement plan that is an improvement plan effective for the problem (Keep) among constituent members of the project.

For example, in the KPT method, Problem sticky notes on each of which a constituent member describes Problem, Try sticky notes on each of which a constituent member describes Try, and Keep sticky notes on each of which a constituent member describes Keep are used. Furthermore, a whiteboard partitioned into a Problem area, onto which the constituent members affix Problem sticky notes, a Try area, onto which the constituent members affix Try sticky notes, and a Keep area, onto which the constituent members affix Keep sticky notes is used.

With the KPT method, one of the constituent members first affixes a Problem sticky note onto the Problem area. Next, a Try sticky note corresponding to a Problem described on this Problem sticky note is affixed onto the Try area. At this moment, if it is determined that a Try described on this Try sticky note is effective for the Problem and should be continued, this Try sticky note is affixed onto the Keep area as a Keep sticky note for the Problem. If it is determined that the Try is not effective for the Problem, a Try sticky note on which a different Try is described is affixed onto the Try area. This cycle is repeated until an effective Try for the Problem is discovered.

JP Publication No. 2006-202255 discloses a method of extracting a process highly likely to obtain an effective improvement effect for productivity of an overall production line (pages 4 to 5 and FIG. 1).

However, with the above-stated conventional technique, it is disadvantageously difficult to accumulate and use operation improvement activity histories based on the KPT method, and it is disadvantageously impossible to share the operation improvement activity histories among a plurality of projects so as to make efficient use of the operation improvement activity histories, as will be described below specifically.

In the conventional KPT method, office and stationary supplies such as the whiteboard and the sticky notes are used. Due to this, it is difficult to accumulate and use past operation improvement activity histories based on the KPT method. According to the conventional KPT method, if a sticky note is removed or the number of sticky notes increases, the relationships among items of Problem, items of Try, and items of Keep are made unclear. For this reason, even in the same project, the problems to be solved that are unconnected to items of Keep cannot be accurately grasped.

Moreover, according to the conventional KPT method, items of Problem, items of Try, and items of Keep are shared only in the individual projects, respectively and are not shared among all the projects in most cases. Due to this, it is disadvantageously impossible to share and make efficient use of the operation improvement activity histories based on the KPT method. It is to be noted that the method disclosed in the JP Publication No. 2006-202255 is not executed on the premise of operation improvement activities based on the KPT method.

To solve these conventional problems, the inventor of the present invention proposes a method of computerizing the KPT method as disclosed in JP Application No. 2006-278689. Specifically, with the method proposed by the inventor of the present invention, an improvement activity support device stores a Problem, a Try, and a Keep in a predetermined storage unit while making them correspond to one another. The improvement activity support device displays items arranged into an always easily visible state by an editing operation performed by constituent members through improvement activities with respect to items of Problem, items of Try, and items of Keep on a display or the like. Even if the items are deleted from (not displayed on) the display or the like, the improvement activity support device also redisplays the deleted items according to necessity.

With the method proposed by the inventor of the present invention, operation improvement activity histories based on the KPT method can be accumulated and used because of the computerized KPT method. Furthermore, the operation improvement activity histories based on the KPT method can be shared among and made efficient use of by a plurality of projects.

However, the method proposed by the inventor of the present invention has the problem that systematic problems cannot be easily grasped, as will be described below specifically.

A systematic problem means a problem difficult to solve by each of a plurality of projects and common to the projects. For example, a responsible person given a right to solve the systematic problem grasps problems, trial improvement plans, and effective improvement plans in the respective projects stored in the predetermined storage unit. Further, the responsible person detects the systematic problem from the information grasped by the responsible person and takes an improvement plan against the systematic problem. Inmost cases, the responsible person having the right to solve the systematic problem is in charge of a plurality of projects. It is difficult for the responsible person in charge of the plural projects to accurately grasp the problems, the trial improvement plans, and the effective improvement plans in the respective projects in real time. Furthermore, it is more difficult for such a responsible person to detect the systematic problem from the grasped information. Namely, the responsible person is unable to easily grasp the systematic problem. Moreover, the responsible person is unable to introduce measures at appropriate timing.

### SUMMARY OF THE INVENTION

According to an aspect of an embodiment, a computer readable recording medium stores an information search program. The program searches information about projects. The program causes the computer to execute a systematic problem search procedure that searches information about a systematic problem from an historical or retrospect storage unit. The systematic problem is common to the plurality of projects. The program uses a conditional expression for searching the information about the systematic problem based on one of or a plurality of (a) a count by which information about the systematic problem is stored in the storage unit, (b) a count by which a trial improvement plan linked to the systematic problem is stored in the retrospect storage unit, and (c) information indicating whether the stored improvement plan is stored in the retrospect storage unit. The conditional expression produces an indication of a condition for extracting the information about the systematic problem. A systematic problem output procedure outputs a search result in the systematic problem search procedure to each of or one of a predetermined storage unit and a predetermined output unit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic diagram explaining outline and features of an information search device according to a first embodiment;

FIG. 2 is a block diagram showing a configuration of the information search device according to the first embodiment;

FIG. 3 is a schematic diagram showing an example of a screen display on a display of the information search device according to the first embodiment;

FIG. 4 is a schematic diagram showing an example of a screen during setting of systematic problem conditions according to the first embodiment;

FIG. 5 is a schematic diagram explaining a retrospect database according to the first embodiment;

FIG. 6 is a schematic diagram explaining an example of configurations of information stored in the retrospect database according to the first embodiment;

FIG. 7 is a schematic diagram explaining a systematic problem candidate database according to the first embodiment;

FIG. 8 is a schematic diagram explaining a systematic problem database according to the first embodiment;

FIG. 9 is a schematic diagram explaining a personnel information database according to the first embodiment;

FIG. 10 is a schematic diagram explaining a systematic problem candidate detection processing using an average count according to the first embodiment;

FIG. 11 is a schematic diagram explaining a systematic problem candidate detection processing using an order of occurrence counts according to the first embodiment;

FIG. 12 is a schematic diagram explaining a systematic problem candidate detection processing using a count of occurrence of problems unconnected to stored improvement plans according to the first embodiment;

FIG. 13 is a schematic diagram explaining a systematic problem detection processing using preset concerned matters according to the first embodiment;

FIG. 14 is a schematic diagram explaining a systematic problem detection processing using TF-IDF according to the first embodiment;

FIG. 15 is a schematic diagram explaining a systematic problem detection processing using a standard deviation according to the first embodiment;

FIG. 16 is a flowchart showing an overall flow of a systematic problem search processing according to the first embodiment;

FIG. 17 is a schematic diagram explaining the systematic problem search processing according to the first embodiment;

FIG. 18 is a schematic diagram explaining a storage unit storing therein information about a higher responsible person according to a second embodiment;

FIG. 19 is a schematic diagram explaining a method of monitoring measures against a systematic problem according to the second embodiment;

FIG. 20 is a flowchart showing a processing related to the measures against the systematic problem according to the second embodiment; and

FIG. 21 is a block diagram showing programs of the information search device according to the first embodiment.

### DETAILED DESCRIPTION OF THE EMBODIMENTS

Embodiments of the present invention will be described hereinafter in detail with reference to the accompanying drawings. Main terms used in each of the embodiments, an outline and features of an information search device according to the embodiments, and a configuration and a processing flow of the information search device according to the embodiments will be described in this order.

### First Embodiment

### [Explanation of Terms]

Main terms used in the embodiments of the present invention will first be described. A “project” used in the embodiments means, for example, members organized in a team to go into action. In other words, the “project” corresponds to, for example, the fact that the team includes a responsible person and a plurality of constituent members who perform an operation.

Further, “Theme” used in the embodiments means information for classifying a Problem to be described later, a Try to be described later, and a Keep to be described later.

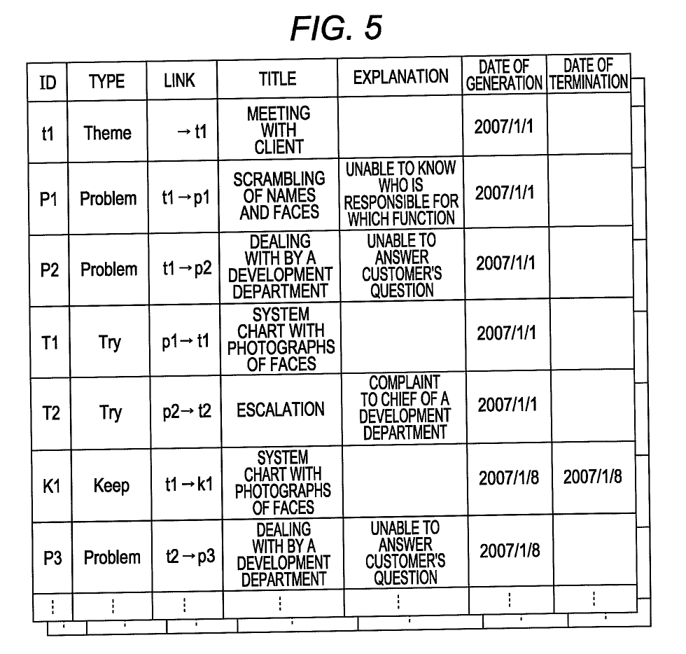

Moreover, “Problem” used in the embodiments means a content to be improved when the team performs an operation in a project. For example, the “Problem” corresponds to information related to thinking back to a content of the operation in the project and to “bad points” discovered in retrospect. Specifically, the “Problem” corresponds to, for example, such information as “dealing with customer, e.g. by Development Department A (unable to answer customer's question)” (see FIG. 5). It is to be noted that the “Problem” corresponds to “information on a problem” set forth in the claims.

Furthermore, “Try” used in the embodiments means improvement plans against a problem. For example, the “Try” corresponds to information related to thinking back to the content of the operation in the project and to “points to be challenged next time” discovered in retrospect. Specifically, the “Try” corresponds to, for example, such information as “escalation (complaint to Chief of Development Department A)” (see FIG. 5). It is to be noted that the “Try” corresponds to “information on a trial improvement plan” set forth in the claims.

“Keep” used in the embodiments means an effective trial improvement plan against a problem. For example, the “Try” corresponds to information related to thinking back to the content of the operation in the project and to “good points” discovered as measures against the problem in retrospect. Specifically, the “Keep” corresponds to, for example, such information as “system chart with photographs of faces” (see FIG. 5). It is to be noted that the “Keep” corresponds to “information on stored improvement plans” set forth in the claims.

“Systematic problem” used in the embodiments means a content to be improved which is common to a plurality of projects. For example, the “systematic problem” corresponds to information difficult to solve by individual projects and related to a common problem to the projects. The systematic problem is a common problem to a plurality of projects. Due to this, it is difficult to grasp the systematic problem even by causing a responsible person in charge of one project to grasp items of Problem, items of Try, and items of Keep in one project. It is to be noted that the “systematic problem” corresponds to “information on a systematic problem” set forth in the claims.

The relationship between the Problem and the systematic problem will be organized in order. The systematic problem is contained in the Problem. In other words, some Problems are systematic problems and others are not systematic problems.

Meanwhile, to grasp such a systematic problem, it is conventionally necessary for a responsible person in charge of a plurality of projects to accurately grasp items of Problem, items of Try, and items of Keep in the respective projects. It is also necessary to grasp which Problems are systematic problems based on the information grasped by the responsible person. The embodiments of the present invention are intended to meet a demand to enable such a responsible person to easily grasp a systematic problem.

### [Outline and Features of Information Search Device]

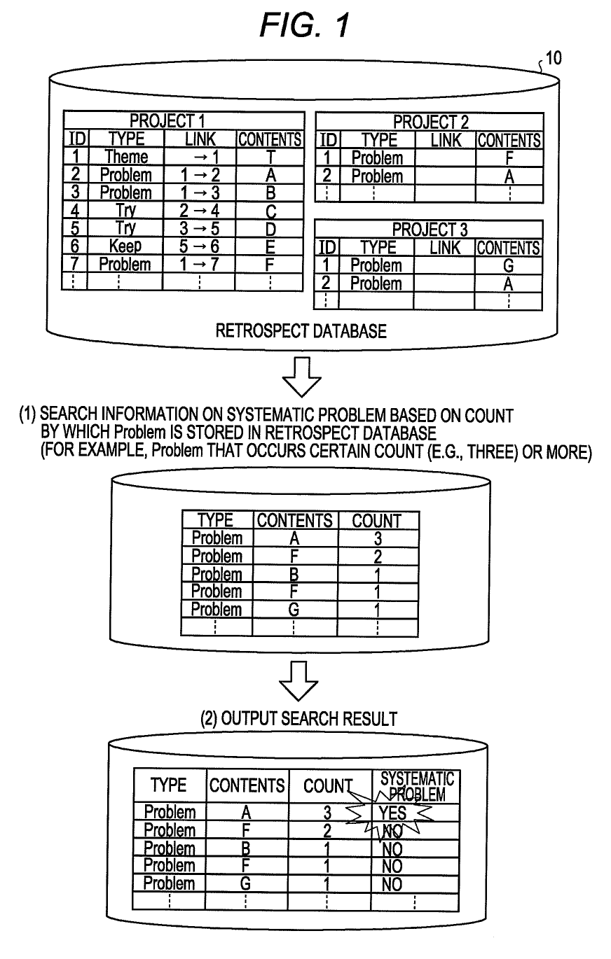

Referring first to FIG. 1, outline and features of the information search device according to the first embodiment will first be described. FIG. 1 is a schematic diagram explaining the outline and features of the information search device according to the first embodiment.

As shown in FIG. 1, the information search device according to the first embodiment is an information search device for searching project-related information and is mainly characterized by easily grasping systematic problems as will be described below.

The main feature of the information search device according to the first embodiment will be described. The information search device stores items of Problem in a plurality of projects whenever they are input to the device, respectively. The information search device stores items of Try whenever they are input thereto, and stores items of Keep whenever they are input thereto. Furthermore, the information search device according to the first embodiment stores the items of Try, the items of Keep in a retrospect database while linking them to the items of Problem, respectively with respect to each of a plurality of projects.

For example, the information search device stores “type”, “link”, and “content” in the retrospect database while making them correspond to “ID”, respectively with respect to each of a plurality of projects. The “type” indicates a type of data such as Keep, Try or Problem. The “link” indicates how each item of Keep and each item of Try is linked to each item of Problem. The “content” indicates a content of data. The “ID” indicates information for uniquely identifying each piece of information in the retrospect database.

The “type”, “link”, “content”, and “ID” will be described specifically while referring to examples. As shown in a retrospect database 10 shown in FIG. 1, the information search device according to the first embodiment stores a type “Problem”, a link “1→3”, and a content “B” while making them correspond to an ID “3”. Further, the information search device stores a type “Try”, a link “3→5”, and a content “D” while making them correspond to an ID “5”. Moreover, the information search device stores a type “Keep”, a link “5→6”, and a content “E” while making them correspond to an ID “6”.

FIG. 1 and the “contents” described in the outline and features will be additionally explained. For convenience of description, the content is described as, for example, “B”. Actually, however, such a content as “dealing with customer by Development Department A (unable to answer customer's question)” is described (stored).

Moreover, FIG. 1 and the “link” described in the outline and features will be additionally explained. For convenience of description, two IDs are described (stored) so as to indicate how an item of Keep and an item of Try are linked to an item of Problem. For example, “1→3” indicates that “information corresponding to ID1 is linked to information corresponding to ID3”. “3→5” indicates that “information corresponding to ID3 is linked to information corresponding to ID5”.

With such a configuration, the information search device searches information about a systematic problem from the retrospect database 10 by using a conditional expression for extracting the systematic problem. This conditional expression is to search information based on one of or a plurality of a count by which an item of Problem is stored in the retrospect database 10, a count by which an item of Try linked to the item of Problem is stored in the retrospect database 10, and information as to whether an item of Keep is stored in the retrospect database 10.

The conditional expression is input and used by, for example, a person grasping systematic problems. In the first embodiment, a method using a conditional expression for searching a problem that “occurs a predetermined count or more” as a systematic problem will be described by way of example. While the method using the conditional expression input and used by the person grasping systematic problems will be described hereafter, the first embodiment is not limited to the method. For example, a plurality of conditional expressions may be incorporated in advance and a user may selectively use one of the conditional expressions at the time of searching a systematic problem. Alternatively, a conditional expression may be incorporated in advance and the user may search a systematic problem only by using the conditional expression.

For example, the information search device searches information on a systematic problem based on the count by which an item of Problem is stored in the retrospect database. Specifically, as shown in (1) of FIG. 1, the information search device searches an item of Problem that occurs more than predetermined count (e.g., three times).

The information search device outputs a search result to the retrospect database 10 and a predetermined output unit. For example, as shown in (2) of FIG. 1, the information search device determines Problem “A” that is the item of Problem that occurs three times or more as a systematic problem and outputs “YES”. Further, the information search device determines Problem “F” that is the item of Problem that does not occur three times or more as a non-systematic problem and outputs “NO”.

By doing so, the information search device can easily grasp the systematic problem as described as the main feature. Namely, the responsible person grasps problems, trial improvement plans, and effective improvement plans in the respective projects stored in the predetermined storage unit. As compared with the conventional method of detecting the systematic problem from the information thus grasped by the responsible person, the method according to the first embodiment enables easily grasping the systematic problem.

### [Configuration of Information Search Device]

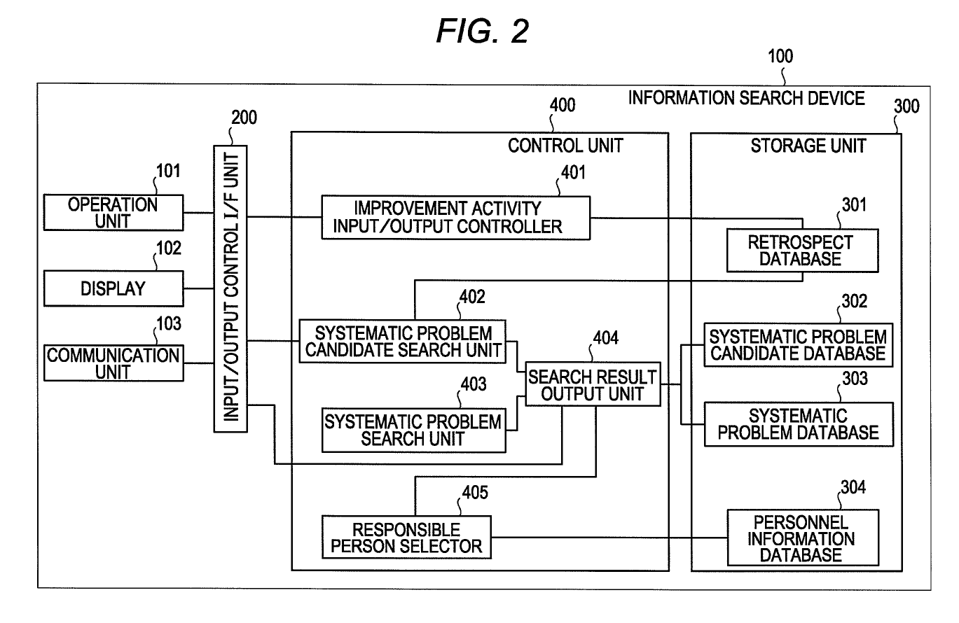

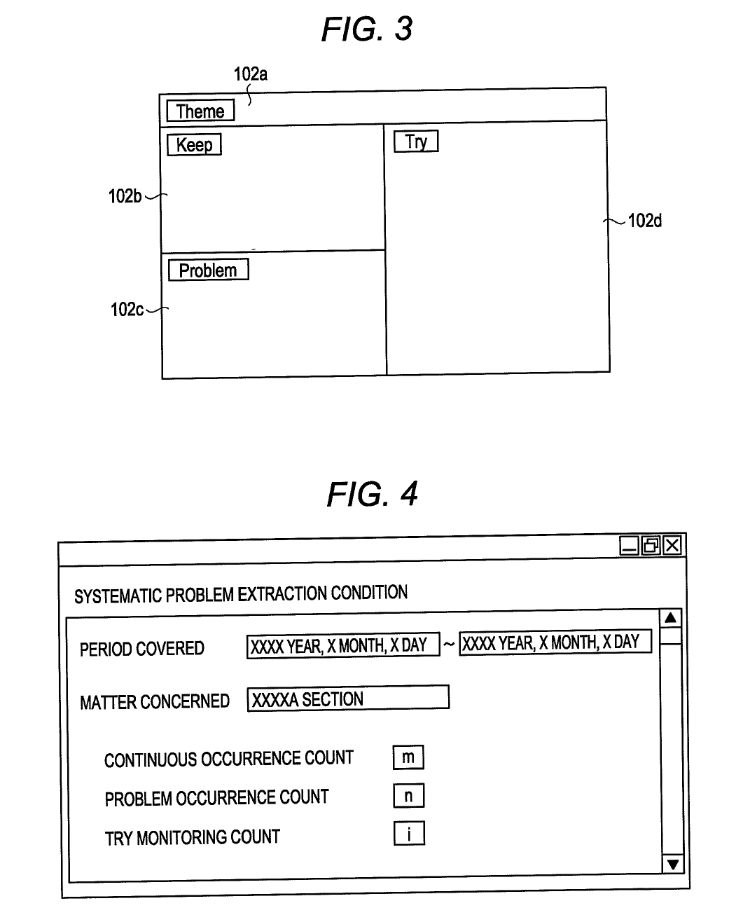

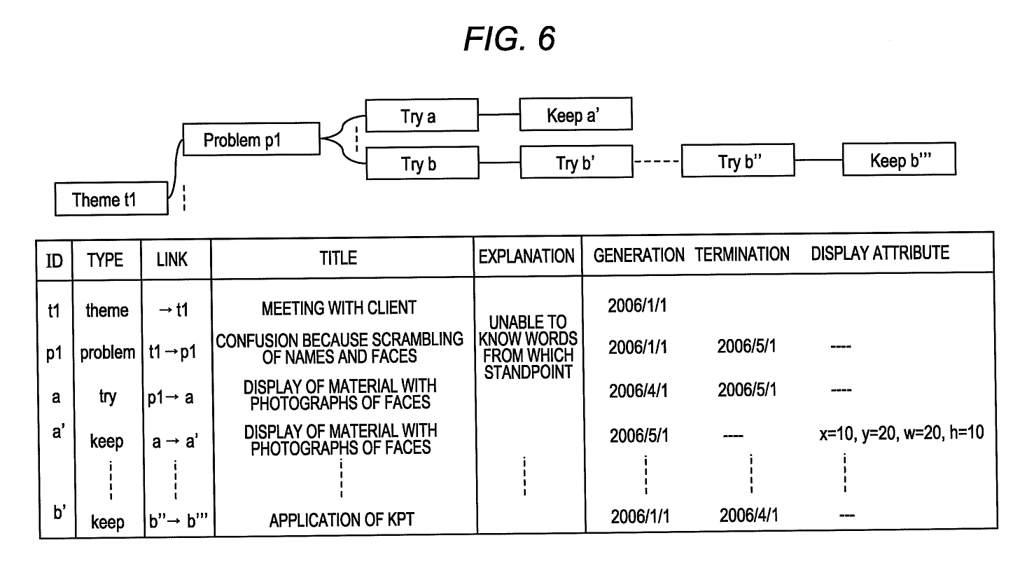

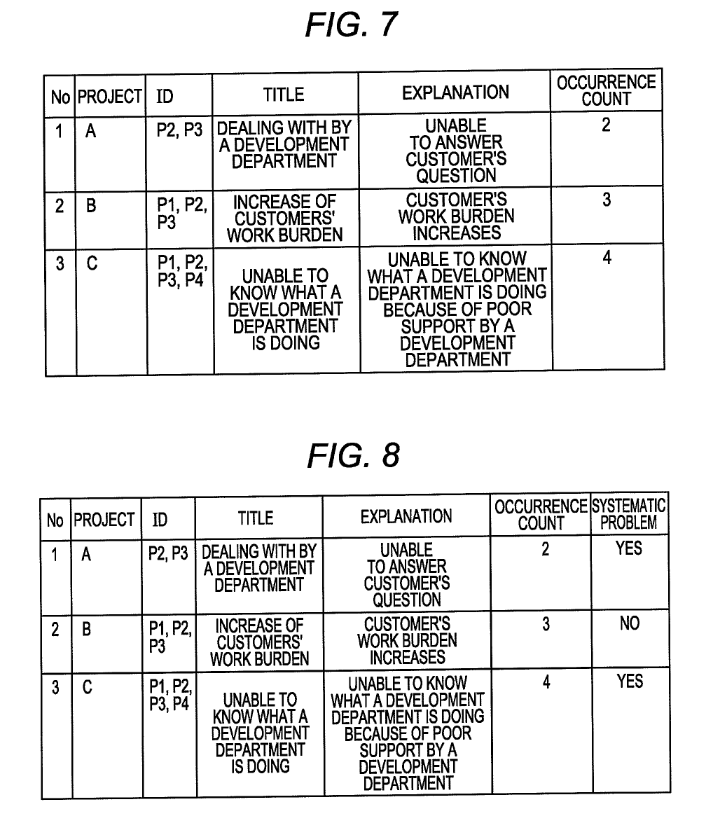

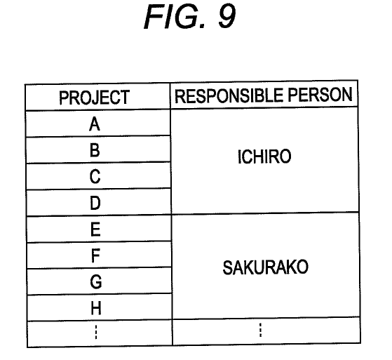

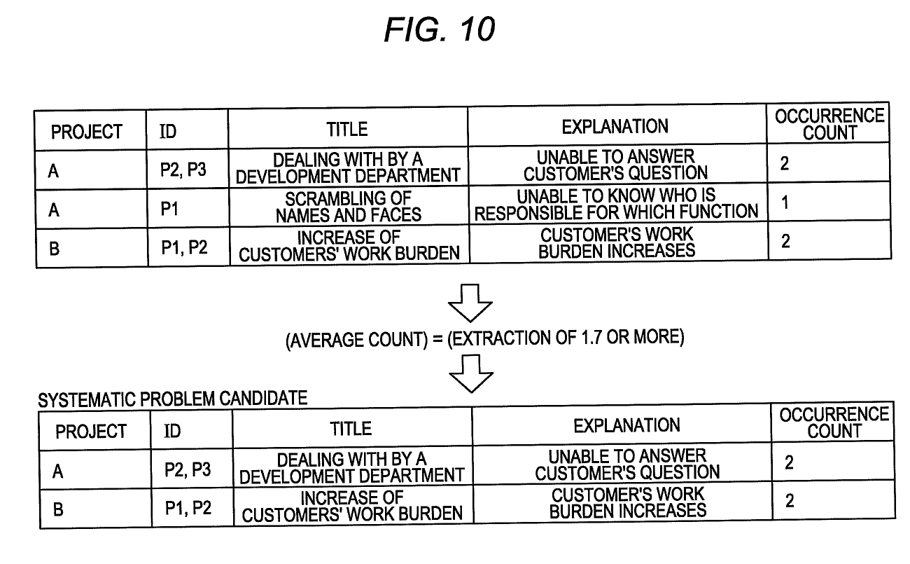

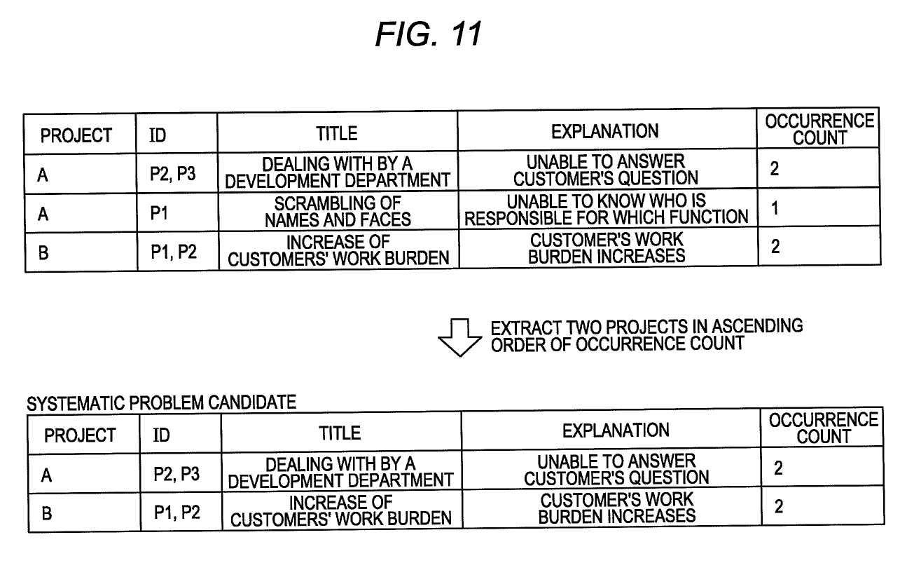

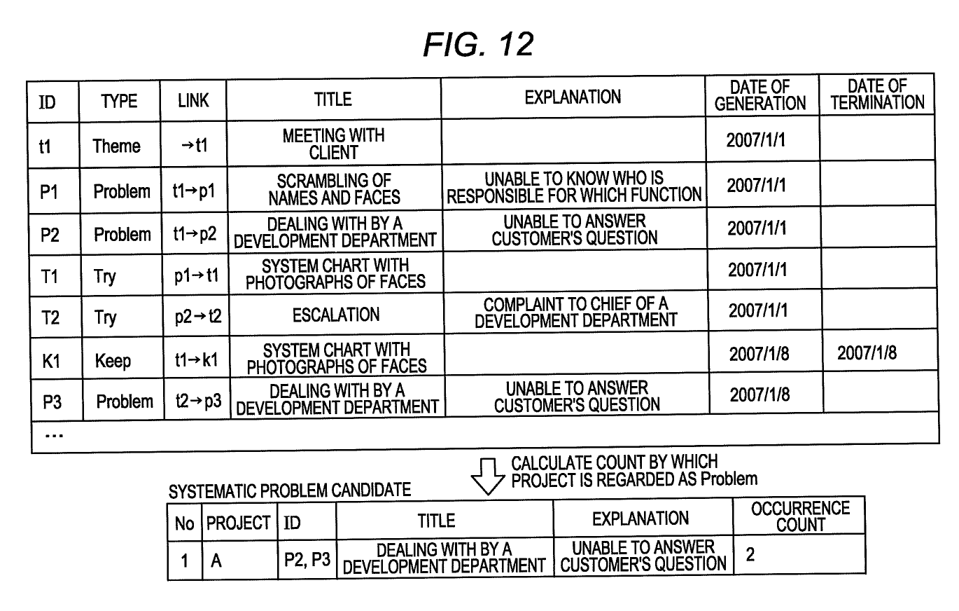

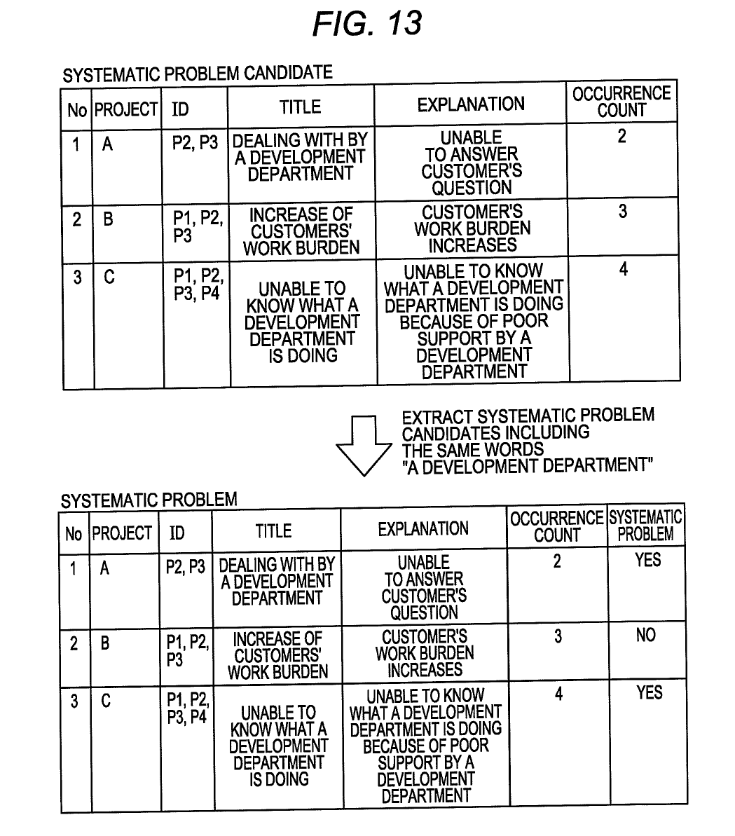

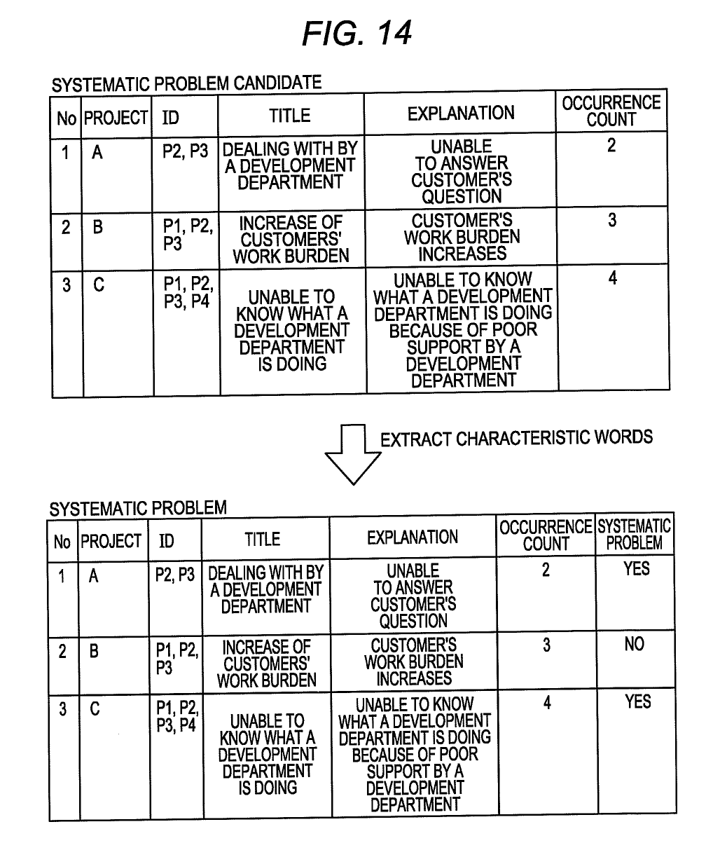

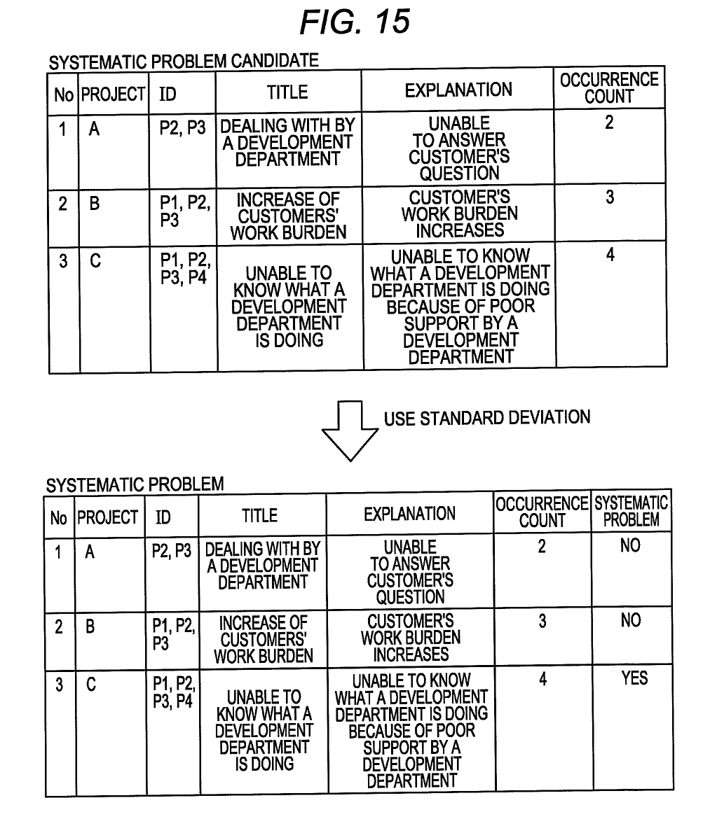

Referring next to FIGS. 2 to 15, the information search device according to the first embodiment will be described. FIG. 2 is a block diagram showing a configuration of the information search device. FIG. 3 is a schematic diagram showing an example of a screen displayed on a display. FIG. 4 is a schematic diagram showing an example of a screen during setting of systematic problem conditions. FIG. 5 is a schematic diagram explaining a retrospect database. FIG. 6 is a schematic diagram explaining an example of configurations of information stored in the retrospect database. FIG. 7 is a schematic diagram explaining a systematic problem candidate database. FIG. 8 is a schematic diagram explaining a systematic problem database. FIG. 9 is a schematic diagram explaining a personnel information database. FIG. 10 is a schematic diagram explaining a systematic problem candidate detection processing using an average count. FIG. 11 is a schematic diagram explaining a systematic problem candidate detection processing using an order of occurrence counts. FIG. 12 is a schematic diagram explaining a systematic problem candidate detection processing using a count of occurrence of problems unconnected to stored improvement plans. FIG. 13 is a schematic diagram explaining a systematic problem detection processing using preset concerned matters. FIG. 14 is a schematic diagram explaining a systematic problem detection processing using TF-IDF. FIG. 15 is a schematic diagram explaining a systematic problem detection processing using a standard deviation.

As shown in FIG. 2, the information search device 100 includes, as units of close relevance to the first embodiment, an operation unit 101, a display 102, a communication unit 103, an input/output control I/F unit 200, a storage unit 300, and a control unit 400.

In the following description of the first embodiment, a systematic problem candidate search unit 402, to be described later, detects systematic problem candidates using a “continuous occurrence account” to be described later unless described otherwise. An instance in which a systematic problem search unit 403, to be described later, detects a systematic problem from the systematic problem candidates using “matters concerned” to be described later.

The operation unit 101 transmits an operation content from a user of the information search device 100 to the information search device 100 in response to an operation from the user. Specifically, the operation unit 101 receives a command to detect a systematic problem to the control unit 400, to be described later, and transmits the command to the control unit 400. For example, the operation unit 101 is configured to include ten keys, operation keys, a rotation selector, a cursor, an arrow key, a setting key, a decision key, a response key, and the like.

The display 102 is a display (e.g., a liquid crystal display or an organic EL display) for displaying characters, graphics and the like. Specifically, the display 102 displays characters and graphics according to a command from the control unit 400. For example, as shown in FIG. 3, the display 102 displays a Theme area 102a, a Keep area 102b, a Problem area 102c, and a Try area 102d. The Theme area 102a is an area in which items of “Theme” are displayed according to a command from an improvement activity input/output control unit 401 to be described later. The Keep area 102b is an area in which items of “Keep” are displayed according to a command from the improvement activity input/output control unit 401. The Problem area 102c is an area in which items of “Problem” are displayed according to a command from the improvement activity input/output control unit 401. The Try area 102d is an area in which items of “Try” are displayed according to a command from the improvement activity input/output control unit 401. It is to be noted that the display 102 corresponds to an “output unit” set forth in claims.

Furthermore, as shown in, for example, FIG. 4, the display 102 displays a screen for accepting conditional expressions used by the systematic problem candidate search unit 402 and the systematic problem search unit 403 to be described later. Specifically, the display 102 displays the screen constituted by a field accepting a “period covered”, a field accepting a “matter concerned”, a field accepting “continuous occurrence count”, a field accepting “problem occurrence count”, and a field accepting a “Try monitoring count”. The “period covered” indicates a coverage of a “date of generation” to which search target data is linked. The “matter concerned” indicates a matter registered in advance when the systematic problem search unit 403 performs a search processing. The “continuous occurrence count” is the number of times used when the systematic problem candidate search unit 402 performs a search processing, i.e., the number of times by which an item of Problem occurs continuously within the period covered and by which the item of Problem is regarded as a systematic problem candidate. The “problem occurrence count” is the number of times used when the systematic problem candidate search unit 402 performs a search processing, i.e., the number of times by which an item of Problem occurs and by which the item of Problem is regarded as a systematic problem candidate. The “Try monitoring count” is the number of times used when the systematic problem candidate search unit 402 performs a search processing, i.e., the number of times by which an item of Try occurs and by which the corresponding item of Problem is regarded as a systematic problem candidate.

The communication unit 103 transmits information to an external terminal via a network or receives information from the external terminal via the network. For example, the communication unit 103 transmits a search result of a search conducted by the systematic problem search unit 403, to be described later, to a responsible person selected by a responsible person selector 405, to be described later, bye-mail according to a command from a search result output unit 404 to be described later. It is to be noted that the communication unit 103 corresponds to the “output unit” set forth in the claims.

While the instance in which the display 102 and the communication unit 103 are employed as the output unit in the information search device according to the first embodiment is described, the present invention is not limited to the instance. For example, a printer or the like may be used as the output unit.

The input/output control I/F unit 200 controls communication about various pieces of information exchanged among the operation unit 101, the display 102, the communication unit 103, the storage unit 300, and the control unit 400.

The storage unit 300 stores therein data and programs necessary for various search processings. As shown in FIG. 2, the storage unit 300 includes a retrospect database 301, a systematic problem candidate database 302, a systematic problem database 303, and a personnel information database 304. The retrospect database 301 corresponds to a “retrospect storage unit” set forth in claims. The personnel information database corresponds to a “responsible person storage unit” sets forth in claims.

The retrospect database 301 stores therein items of Problem of each of the projects whenever an item of Problem is input, stores therein items of Try whenever an item of Try is input, and stores therein items of Keep whenever an item of Keep is input. Each item of Try and each item of Keep are stored in the retrospect database 301 while linking them to each item of Problem with respect to each of a plurality of projects. For example, the retrospect database 301 stores therein such information as Keep, Try, and Problem according to a command from the improvement activity input/output control unit 401, to be described later. The systematic problem candidate search unit 402, to be described later, uses the information such as Keep, Try, and Problem.

For example, as shown in FIG. 5, the retrospect database 301 stores therein “type”, “link”, “title”, “explanation”, “date of generation”, and “data of termination” while making them correspond to “ID” indicating information for uniquely identifying information. The “type” indicates a type of data such as Keep, Try or Problem. The “link” indicates how Keep and Try are linked to Problem. The “title” indicates a title of information such as Keep, Try, and Problem stored in the retrospect database 301. The “explanation” indicates a content of data such as Keep, Try, and Problem. The “date of generation” indicates a data at which the stored information is input and generated. The “date of termination” indicates a date at which the input data is terminated. The “ID” indicates information for uniquely identifying information in the retrospect database 301.

Specifically, in the example shown in FIG. 5, the retrospect database 301 stores therein a type “Problem”, a link “t1→p1”, a title “scrambling of names and faces”, an explanation “unable to know who is responsible for which function”, and a date of generation “2007/1/1” while making them correspond to the ID “p1”. Further, the retrospect database 301 stores therein a type “Try”, a link “p1→t1”, a title “system chart with photographs of faces”, and a date of generation “2007/1/1” while making them correspond to the ID “T1”. Moreover, the retrospect database 301 stores therein a type “Keep”, a link “t1→k1”, a title “system chart with photographs of faces”, a date of generation “2007/1/8”, and a data of termination “2007/1/8” while making them correspond to the ID “K1”.

Referring to FIG. 6, configurations of “Theme”, “Problem”, “Try”, and “Keep” stored in the retrospect database 301 will be described. As shown in FIG. 6, the retrospect database 301 stores therein “Problem” while making it correspond to “Theme”. Further, the retrospect database 301 stores therein “Try” and “Keep” while making them correspond to “Problem”. “Display attribute” shown in FIG. 6 means information for indicating to which location on the display 102 information is output (displayed) when the information is output to the display 102.

The systematic problem candidate database 302 stores therein search results of searches conducted by the systematic problem candidate search unit 402. Specifically, the search result output unit 404, to be described later, stores systematic problem candidates in the systematic problem candidate database 302. The systematic problem search unit 403, to be described later, uses the stored systematic problem candidates. For example, as shown in FIG. 7, “project”, “ID”, “title”, “explanation”, and “occurrence count” are stored in the systematic problem candidate database 302 while making them correspond to “No” indicating information for uniquely identifying information in the systematic problem candidate database 302. The “project” indicates information as to about which project an item of information is. The “occurrence count” is the number of times by which a corresponding item of Problem is stored in the retrospect database 301 (by which the item of Problem occurs). Specifically, in the example shown in FIG. 7, the systematic problem candidate database 302 stores therein a project “A”, and IDs “P2, P3”, a title “dealing with customer by Development Department A”, an explanation “unable to answer customer's question”, and an occurrence count “2” while making them correspond to No “1”.

The systematic problem database 303 stores therein search results of searches conducted by the systematic problem search unit 403 to be described later. Specifically, the search result output unit 404, to be described later, stores systematic problems in the systematic problem database 303. The stored systematic problems are output from the display 102 or the like. For example, as shown in FIG. 8, “project”, “ID”, “title”, “explanation”, “occurrence count”, and “systematic problem” indicating whether a problem is a systematic problem are stored in the systematic problem database 303 while making them correspond to “No”. Specifically, in the example shown in FIG. 8, the systematic problem database 303 stores therein a project “A”, and IDs “P2, P3”, a title “dealing with by A Development Department”, an explanation “unable to answer customer's question”, an occurrence count “2”, and a systematic problem “YES” while making them correspond to No “1”.

The personnel information database 304 stores therein information about responsible persons in charge of a plurality of projects for the projects, respectively. The information stored in the personnel information database 304 is used by the search result output unit 404 to be described later. In the example shown in FIG. 9, the personnel information database 304 stores therein a “project” and a “responsible person” while making them correspond to a “responsible person” showing a responsible person in charge of this project. Specifically, in the example shown in FIG. 9, the personnel information database 304 stores therein projects “A, B, C, and D” and a responsible person “Ichiro” while making them correspond to each other. Further, the personnel information database 304 stores therein projects “E, F, G, and H” and a responsible person “Sakurako” while making them correspond to each other.

The control unit 400 includes an internal memory storing therein control programs such as one for an OS (Operating System), programs defining various search processing procedures and the like, and required data. The control unit 400 controls the information search device 100 by performing various processings using these programs. The control unit 400 includes, as units of close relevance to the first embodiment of the present invention, the improvement activity input/output control unit 401, the systematic problem candidate search unit 402, the systematic problem search unit 403, the search result output unit 404, and the responsible person selector 405 as shown in FIG. 2.

It is to be noted that the systematic problem candidate search unit 402 and the systematic problem search unit 403 correspond to a “systematic problem search procedure” set forth in the claims. The search result output unit 404 corresponds to a “systematic problem output procedure” set forth in the claims. The responsible person selector 405 corresponds to a “responsible person selection procedure” set forth in the claims.

The improvement activity input/output control unit 401 stores items of Problems of each of the projects in the retrospect database 301 whenever an item of Problem is input. The improvement activity input/output control unit 401 stores items of Try of each of the projects in the retrospect database 301 whenever an item of Try is input. The improvement activity input/output control unit 401 stores items of Keep of each of the projects in the retrospect database 301 whenever an item of Keep is input. Further, the improvement activity input/output control unit 401 stores each item of Try and each item of Keep in the retrospect database 301 while linking them to each item of Problem with respect to each of a plurality of projects. Further, the improvement activity input/output control unit 401 outputs such information as Keep, Try, and Problem stored in the retrospect database 301 from the display 102 or the communication unit 103.

For example, the improvement activity input/output control unit 401 stores an item of Problem in the retrospect database 301 when the item of Problem is input from the operation unit 101. Furthermore, if receiving a command to output an item of Keep from the operation unit 101, the improvement activity input/output control unit 401 outputs the item of Keep from the display 102.

Each of the systematic problem candidate search unit 402 and the systematic problem search unit 403 searches information about a systematic problem from the retrospect database 301 by using a conditional expression indicating conditions for extracting the information about the systematic problem that is a common problem to a plurality of projects with respect to the retrospect database 301. This conditional expression is based on one of or a plurality of a count by which an item of Problem is stored in the retrospect database 301, a count by which an item of Try linked to the item of Problem is stored in the retrospect database 301, and information indicating whether an item of Keep linked to the item of Problem is stored in the retrospect database 301. The search result output unit 404, to be described later, outputs search results of searches conducted by the systematic problem candidate search unit 402 and the systematic problem search unit 403 to the systematic problem candidate database 302 and the systematic problem database 303, respectively.

Each of systematic problem candidate search unit 402 and the systematic problem search unit 403 searches the information about the systematic problem from the retrospect database 301 while narrowing down the information about the systematic problem for each of a plurality of different conditional expressions by using the plurality of different conditional expressions. For example, the systematic problem candidate search unit 402 searches systematic problem candidates from the retrospect database 301 using a certain conditional expression. Next, the systematic problem search unit 403 searches a systematic problem from among the systematic problem candidates searched by the systematic problem candidate search unit 402 by narrowing down systematic problems using different conditional expressions.

Specific examples of searches conducted by the systematic problem candidate search unit 402 and the systematic problem search unit 403 will be described. The systematic problem candidate search unit 402 searches systematic problem candidates using a “continuous occurrence count”. Specifically, the systematic problem candidate search unit 402 extracts information linked to a date of generation within a covered period, a continuous occurrence count, and a search command used when a search processing is performed as input from the operation unit 101. The systematic problem candidate search unit 402 extracts information the type of which is “Problem” from information extracted using dates of generation. Thereafter, the systematic problem candidate search unit 402 compares titles of the information extracted using the types, determines how often information linked to a common (or similar) title is stored, and acquires a search result satisfying a condition about the input continuous occurrence count.

Furthermore, as an example shown in FIG. 5, an instance in which the systematic problem candidate search unit 402 inputs a period covered “2006/1/1” to “2007/12/12” and a continuous occurrence count “2” will be described. The systematic problem candidate search unit 402 extracts information about IDs “t1”, “P1”, “P2”, “T1”, “T2”, “K1” and “P3” as information linked to dates of generation within a period covered “2007/1/1” and “2007/1/8”. Next, the systematic problem candidate search unit 402 extracts information about the IDs “P1”, “P2”, and “P3” as information the types of which is Problem. The systematic problem candidate search unit 402 compares the titles of the extracted information, determines that a count by which the title “scrambling of faces and names” is stored is “1”, and determines that a count by which the title “dealing with by A Development Department” is stored is “2”. The systematic problem candidate search unit 402 acquires a search result in which the IDs “P2, P3”, the title “dealing with by Development Department A”, the explanation “unable to answer customer's question”, the occurrence count “2” are linked to one another as a search result satisfying the stored continuous occurrence count “2”.

The systematic problem search unit 403 searches a systematic problem using a “matter concerned”. Specifically and for example, the systematic problem search unit 403 compares the titles of the systematic problem candidates stored in the systematic problem candidate database 302 with a matter concerned input in advance if a matter concerned and a search command have been input. The systematic problem search unit 403 acquires a search result in which the systematic problem candidate linked to the title coincident with the matter concerned is determined as the systematic problem.

In this case, the systematic problem search unit 403 may set and use matters for which problems are considered to occur as key items, and may store matters concerned in a database (concerned matter database) storing therein matters concerned and use the stored matters concerned.

As another example, an instance in which the systematic problem search unit 403 inputs a matter concerning “Development Department A” will be described. In the example shown in FIG. 7, the systematic problem search unit 403 compares the title “dealing with by Development Department A”, “increase of customers' work burden”, and “Unable to know what Development Department A is doing” that are titles of the systematic problem candidates stored in the systematic problem candidate database 302 with the matter concerned “Development Department A”. In the example shown in FIGS. 7 and 8, the systematic problem search unit 403 acquires a search result in which the systematic problem candidates linked to “dealing with customer, e.g., by A Development Department” and “Unable to know what Development Department A is doing” that are titles coincident with the matter concerned “Development Department A” are systematic problems “YES”.

Search methods used by the systematic problem candidate search unit 402 and the systematic problem search unit 403 will be further described. In the first embodiment, the method of causing the systematic problem candidate search unit 402 to search systematic problem candidates using the “continuous occurrence count” and the method of causing the systematic problem search unit 403 to search systematic problems using the “matter concerned” have been described. However, the first embodiment is not limited to the methods. Alternatively, systematic problems may be searched by one search processing. In other words, systematic problems may be directly detected from the retrospect database 301 without detecting systematic problem candidates. In another alternative, the search methods used by the systematic problem candidate search unit 402 and the systematic problem search unit 403 may be replaced with each other. For example, the systematic problem search unit 403 may detect systematic problem candidates using the “matter concerned” and the systematic problem candidate search unit 402 may detect systematic problems using the “continuous occurrence count”.

The instance in which the systematic problem candidate search unit 402 detects systematic problem candidates using the “continuous occurrence count” has been described above. However, the first embodiment is not limited to the example. For example, as shown in FIG. 10, the systematic problem candidate search unit 402 may calculate an average count of occurrence counts and detect items of Problems occurrence counts which are equal to or higher than the average count as systematic problem candidates. Specifically, in the example shown in FIG. 10, the systematic problem candidate search unit 402 may calculate an average count “1.7” from occurrence counts “2”, “1”, and “2”, extract information linked to occurrence counts equal to or higher than the average count “1.7”, and detect the extracted information as systematic problem candidates.

Further, as shown in FIG. 11, the systematic problem candidate search unit 402 may detect items of Problem in ascending order of count by which each item of Problem is stored (occurrence count) by the number input in advance as systematic problem candidates. Specifically, in the example shown in FIG. 11, the systematic problem candidate search unit 402 may detect “2” items of Problem in ascending order of occurrence count as systematic problem candidates.

Alternatively, as shown in FIG. 12, the systematic problem candidate search unit 402 may detect systematic problem candidates using a count by which an item of Problem unlinked to an item of Keep is stored. Specifically, in the example shown in FIG. 12, the systematic problem candidate search unit 402 calculates a count by which each item of Problem unlinked to an item of Keep occurs (by which each item of Problem is regarded as Problem” and detect an item of Problem the occurrence count of which is equal to or higher than a predetermined count as a systematic problem candidate.

In another alternative, the systematic problem candidate search unit 402 may detect systematic problem candidates using a count by which an item of Try linked to each item of Problem is input. Specifically and for example, the systematic problem candidate search unit 402 may calculate a count by which each item of Try linked to each item of Problem occurs and detect the item of Problem linked to item of Try the occurrence count of which is equal to or higher than the predetermined count as a systematic problem candidate.

The instance in which the systematic problem search unit 403 detects systematic problems using the “matter concerned” has been described above. However, the first embodiment is not limited to the instance. For example, as shown in FIG. 13, if the same words are included in items of Problem, the items of Problem may be detected as systematic problems. Namely, the systematic problem search unit 403 determines whether systematic problem candidates including the same words in titles or explanations are present for all the systematic problem candidates. If the systematic problem candidates including the same words are present, then the systematic problem search unit 403 detects the systematic problem candidates including the same words as systematic problem candidates, and outputs “YES”. Further, the systematic problem search unit 403 determines whether the same words are included in the systematic problem candidates, determines systematic problem candidates linked to Nos. “1” and “3” including the same words “Development Department A” as systematic problems, and outputs “YES”.

Alternatively, the systematic problem search unit 403 may calculate characteristic words included in the systematic problem candidates using a preset calculational expression to the systematic problem candidates and then detect systematic problem candidates including such characteristic words as systematic problems. Specifically, as shown in FIG. 14, for example, the systematic problem search unit 403 extracts “titles” and “explanations” from the systematic problem candidates (from the systematic problem candidate database 302) and extracts characteristic words using a preset calculational expression. Thereafter, the systematic problem search unit 403 determines whether each systematic problem candidate includes the extracted characteristic words, and detects the systematic problem candidates including the characteristic words as systematic problems, and outputs “YES”. In the example shown in FIG. 13, the systematic problem search unit 403 extracts characteristic words “Development Department A” from the systematic problem candidates, detects the systematic problem candidates including “Development Department A” and linked to Nos. “1” and “3” as systematic problems, and outputs “YES” for the systematic problems. In this case, the systematic problem search unit 403 may use TF-IDF (Term Frequency, Inverse Document Frequency) as the preset calculational expression, and detect systematic problem candidates including a typical keyword as systematic problems.

In another alternative, the systematic problem search unit 403 may set a standard deviation of occurrence counts to a threshold value and detect systematic problem candidate the occurrence counts of which exceed the threshold value as systematic problems. Specifically, as shown in FIG. 15, for example, the systematic problem search unit 403 calculates a standard deviation from the systematic problem candidates stored in the systematic problem candidate database 302 with their occurrence counts used as input data. Further, the systematic problem search unit 403 determines whether the occurrence count of each of the systematic problem candidate exceeds the calculated standard deviation, detects the systematic problem candidate the occurrence count of which is equal to or higher than the standard deviation (e.g., equal to or higher than “4”) (e.g., the systematic problem candidate linked to No “3”) as a systematic problem, and outputs “YES” for the systematic problem candidate.

The search result output unit 404 outputs search results from the retrospect database 301 to the display 102 or the communication unit 103. For example, if the systematic problem candidate search unit 402 acquires a search result, the search result output unit 404 stores the search result in the systematic problem candidate database 302. Further, if the systematic problem search unit 403 acquires a search result, the search result output unit 404 stores the search result in the systematic problem database 303. The search result output unit 404 outputs the search result on the display 102.

In the example shown in FIG. 7, if the systematic problem candidate search unit 402 acquires the search result in which the IDs “P2, P3”, the title “dealing with by Development Department A”, the explanation “unable to answer customer's question”, and the occurrence count “2” are made to correspond to one another for systematic problem candidates, the search result output unit 404 stores this search result to the systematic problem candidate database 302. In the example shown in FIG. 8, if the systematic problem search unit 403 acquires the search result in which the systematic problem candidates linked to “dealing with by Development Department A” and “unable to know what Development Department A is doing”, are determined as systematic problems by “YES”, the search result output unit 404 stores this search result to the systematic problem database 303. Further, the search result output unit 404 displays the search result obtained by the systematic problem search unit 403 from the display 102.

The search result output unit 404 outputs a search result using information about a responsible person selected by the responsible person selector 405. In this case, the responsible person selector 405 selects information about a responsible person in charge of the project related to the search result from the personnel information database 304. Further, the responsible person selector 405 transmits information about responsible persons related to the systematic problems obtained by the systematic problem search unit 403 to the search result output unit 404.

For example, if the search result obtained by the systematic problem search unit 403 is related to a project H, the responsible person selector 405 selects “Sakurako” who is the responsible person linked to the project H from the personnel information database 304. The search result output unit 404 selects the responsible person “Sakurako” selected by the responsible person selector 405. The systematic problem search unit 403 acquires a search result in which the systematic problem candidate linked to “dealing with customer by Development Department A” and “unable to know what A Development Department is doing” are determined as the systematic problem by “YES”, and outputs the search result from the display 102. The systematic problem search unit 403 displays “Sakurako” as a name of the responsible person related to the search result about the systematic problem and notifies the responsible person of the systematic problem.

The instance in which the personnel information database 304 stores therein responsible persons and in which the search result output unit 404 displays the responsible person selected by the responsible person selector 405 from the display 102 has been described above. However, the present invention is not limited to that example. Alternatively, the search result output unit 404 may notify the responsible person via communication unit 103. For example, the personnel information database 304 may store therein “projects” and “responsible person contact information” indicating contact information (e.g., an e-mail address, a telephone number or an IP address) on a responsible person in charge of each of the projects while linking the “projects” to the “responsible person contact information”, respectively. With such a configuration, the responsible person selector 405 may select one contact information from the “responsible person contact information”, and the search result output unit 404 may notify the selected contact information of the systematic problem.

In another alternative, the search result output unit 404 may determine whether to move an input item of Try to items of Keep or items of Problem. If the input item of Try is moved to items of Problem, the search result output unit 404 may notify the responsible person in charge of the project of the input item of Try. If items of Try are not moved to items of Keep a predetermined number of times or more, the search result output unit 404 may re-notify the responsible person in charge of the project of the input item of Try.

The constituent elements of the information search device 100 according to the first embodiment have been described so far. The information search device 100 can be realized by incorporating such functions as the systematic problem candidate search unit 402, the systematic problem search unit 403, the search result output unit 404, the retrospect database 301, the systematic problem candidate database 302, and the systematic problem database 303 stated above into an information processing device such as a well-known personal computer, workstation, portable telephone, PHS terminal, mobile communication terminal or PDA.

### [Flow of Overall Processing Performed by Information Search Device]

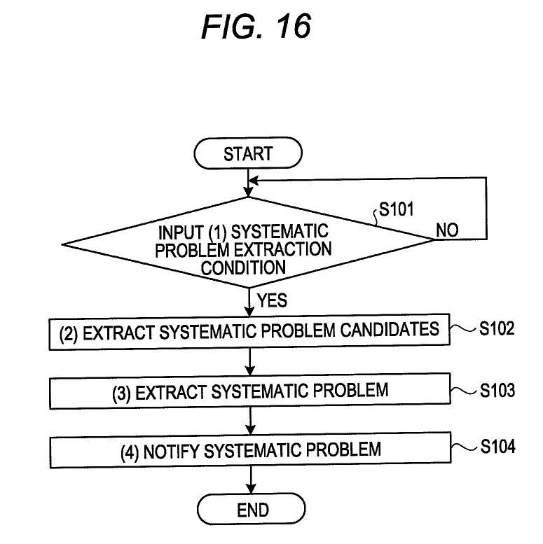

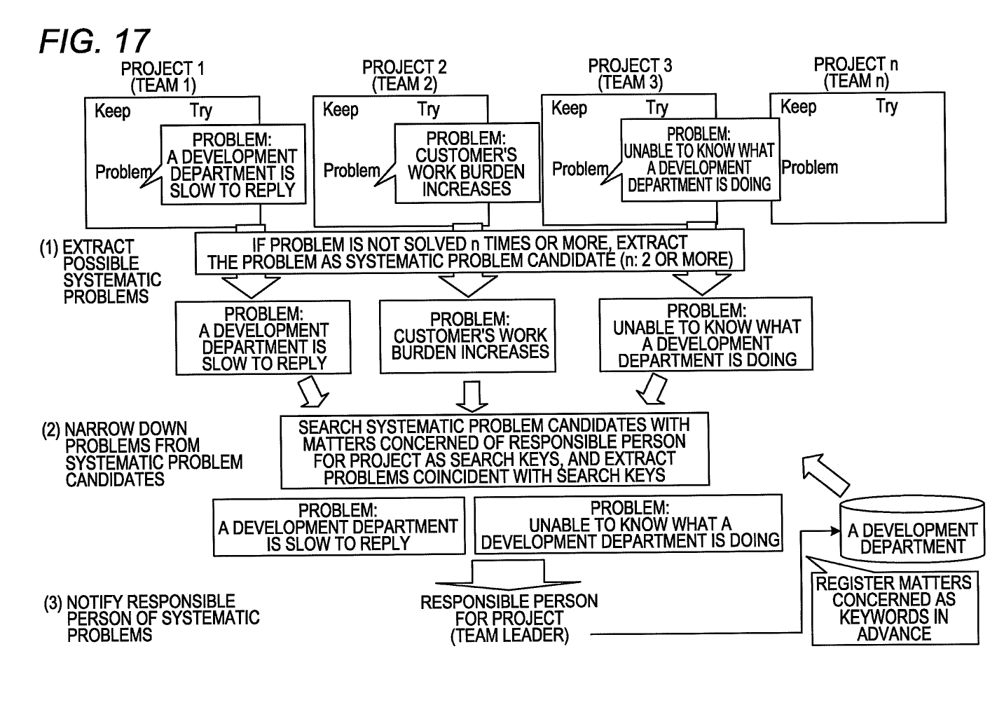

Referring next to FIGS. 16 and 17, the flow of overall processing performed by the information search device according to the first embodiment will be described. FIG. 16 is a flowchart showing a flow of an overall systematic problem search processing according to the first embodiment. FIG. 17 is a schematic diagram explaining the systematic problem search processing according to the first embodiment.

As shown in FIG. 16, if a systematic problem extraction condition is input (step S101; Yes), the systematic problem candidate search unit 402 extracts systematic problem candidates (step S102). Namely, the systematic problem candidate search unit 402 searches systematic problem candidates. In the example shown in (1) of FIG. 17, if “if problem is not solved n times or more, extract the problem as systematic problem candidate” is input as a conditional expression, the systematic problem candidate search unit 402 extracts possible systematic problems from items of Problem related to projects 1 to n. In the example shown in FIG. 17, the systematic problem candidate search unit 402 extracts “Development Department A is slow to reply”, “customer's work burden increases”, and “Unable to know what Development Department A is doing”.

The systematic problem search unit 403 extracts a systematic problem (step S103). Namely, the systematic problem search unit 403 searches a systematic problem. In the example shown in (2) of FIG. 17, the systematic problem search unit 403 narrows down the systematic problem candidate. In other words, in the example shown in (2) of FIG. 17, the systematic problem search unit 403 searches systematic problem candidates and extracts systematic problem candidates coincident with search keys with the matters concerned of the responsible persons in charge of the projects set as the search keys, respectively. In the example shown in (2) of FIG. 17, the systematic problem search unit 403 extracts “Development Department A is slow to reply” and “Unable to know what Development Department A is doing” using “Development Department A” that is the preset matter concerned.

The search result output unit 404 notifies the responsible persons of the systematic problems (step S104). Namely, the search result output unit 404 outputs a search result. In the example shown in (3) of FIG. 17, the search result output unit 404 notifies the responsible person of the systematic problem. In other words, in the example shown in (3) of FIG. 17, the search result output unit 404 notifies the responsible persons in charge of the respective projects (team leaders) of the search result.

### Advantage of First Embodiment

As stated above, according to the first embodiment, it is possible to easily grasp systematic problems.

Specifically, according to the first embodiment, as compared with the conventional method of causing each responsible person to grasp problems, trial improvement plans, and stored improvement plans for the each corresponding project stored in the predetermined storage unit (retrospect storage unit), and to detect systematic problems from these pieces of grasped information, the systematic problems can be easily grasped according to the first embodiment.

Furthermore, according to the first embodiment, the systematic problems can be grasped more accurately.

Specifically, according to the first embodiment, the information search device searches systematic problems using different search expressions a plurality of times. By doing so, as compared with the method of searching systematic problems using only one search expression, the systematic problems can be searched more accurately.

Moreover, according to the first embodiment, the search result can be easily notified to the responsible person in charge of the project related to the search result.

For example, according to the first embodiment, if a search result indicating that a certain problem is a systematic problem is acquired, the information search device notifies the responsible persons in charge of the systematic problems (responsible persons in charge of the respective projects) of the search result. It is thereby possible to notify the responsible persons that it is difficult to solve the problem by the responsible persons and that measures taken against the problem by the responsible persons are not effective. Further, the information search device can urge the responsible persons in charge of the respective projects to take measures against other problems (problems other than the systematic problems, i.e., problems that can be solved by the responsible persons in charge of the respective projects).

Furthermore, for example, according to the first embodiment, if the search result indicating that a certain problem is a systematic problem is acquired, the information search device notifies the responsible persons in charge of the systematic problems (responsible persons in charge of a plurality of projects, respectively) of the search result. It is possible to urge the responsible persons in charge of the respective projects to take measures against the systematic problem.

For example, according to the first embodiment, if a search result indicating that a certain problem is not a systematic problem is acquired, the information search device notifies the responsible persons in charge of the problem and of the respective projects of the search result. It is thereby possible to urge the responsible persons to take measures against the problem.

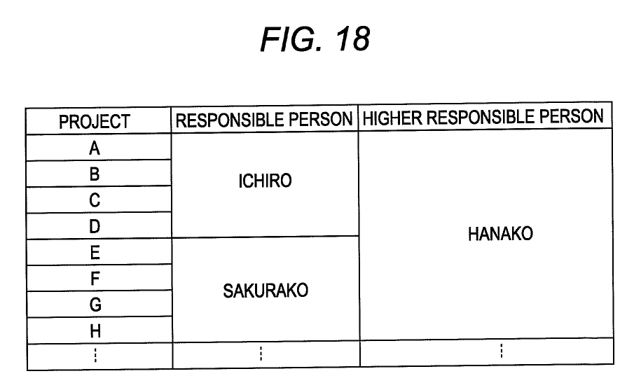

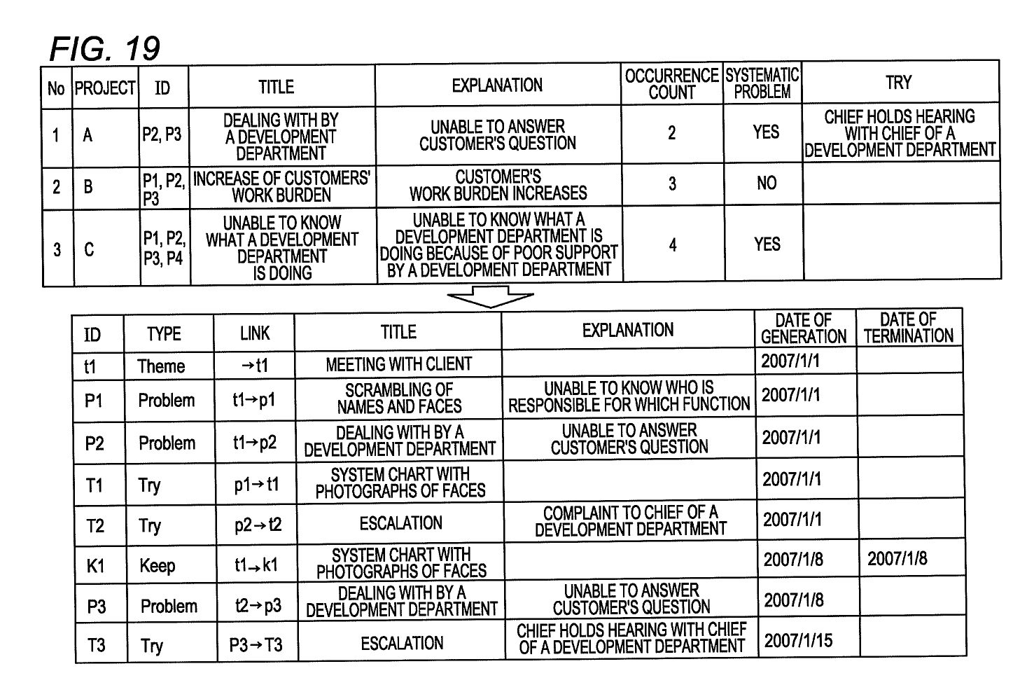

In the first embodiment, a method of, after the search result (systematic problem) is output, monitoring a situation of taking a measure against the systematic problem has not been specially mentioned. However, the present invention is not limited to the first embodiment but the situation of taking a measure may be monitored. Therefore, in a second embodiment of the present invention, a method of monitoring a situation of taking a measure against a systematic problem will be described with reference to FIGS. 18 and 19. FIG. 18 is a schematic diagram explaining a storage unit storing therein information about a higher responsible person according to the second embodiment. FIG. 19 is a schematic diagram explaining a method of monitoring measures against a systematic problem according to the second embodiment. Same constituent elements of an information search device according to the second embodiment as those of the information search device according to the first embodiment will be described only briefly.

Namely, the information search device according to the second embodiment includes a higher person storage unit that stores therein information about a higher responsible person who is a responsible person governing the responsible persons in charge of the respective projects. For example, as shown in FIG. 18, “projects”, “responsible persons”, and a “higher responsible person” indicating a higher responsible person are stored in the higher person storage unit while linking them to one another. In the example shown in FIG. 18, the information search device according to the second embodiment stores “Hanako” as a higher responsible person governing “Ichiro” who is a responsible person in charge of projects “A, B, C, and D” and “Sakurako” who is a responsible person in charge of projects “E, F, G, and H” in the higher person storage unit.

With such a configuration, the information search device according to the second embodiment includes not only the constituent elements of the information search device according to the first embodiment but also a first monitoring unit, a first monitoring result output unit, a second monitoring unit, a second monitoring result output unit, and a higher person selector in the control unit 400. It is to be noted that the first monitoring unit corresponds to a “first monitoring procedure” set forth in the claims. The second monitoring unit corresponds to a “second monitoring procedure” set forth in the claims. The first monitoring result output unit corresponds to a “first monitoring result output procedure” set forth in the claims. The second monitoring result output unit corresponds to a “second monitoring result output procedure” set forth in the claims.

Processings performed by these constituent elements will be described. The first monitoring unit monitors whether an item of Keep linked to an item of Problem is not input to the retrospect database 301 and whether an item of Try linked to the item of Problem has not been input to the retrospect database 301 for a predetermined time if information about a systematic problem is searched by the systematic problem search unit 403. For example, if the search result is notified to the responsible persons, the first monitoring unit monitors whether the responsible persons notified of the search result inputs an item of Try to the retrospect database 301.

The second monitoring unit monitors whether the item of Keep linked to the item of Problem has not been input to the retrospect database 301 for a predetermined time if the information about the systematic problem is searched by the systematic problem search unit 403.

For example, the first monitoring unit will be described while referring to a detailed example. The first monitoring unit monitors whether an item of Try corresponding to the search result is input. If the first monitoring unit acquires a monitoring result indicating that an item of Try is input, the first monitoring unit notifies the first monitoring result output unit, to be described later, of the monitoring result.

The first monitoring unit will be described while referring to another detailed example. The first monitoring unit determines whether it is monitoring timing. If it is not monitoring timing, the first monitoring unit continues to determine whether it is the monitoring timing until the monitoring timing comes. If determining that it is the monitoring timing, the first monitoring unit monitors whether an item of Keep linked to the item of Try (that is, an item of Keep linked to the item of Problem to which the item of Try is linked) is input. Furthermore, the first monitoring unit monitors whether a new item of Try linked to the item of Try (that is, an item of Try linked to the item of Problem to which the item of Try is linked) is input. If an item of Keep linked to the item of Try is input, the first monitoring unit finishes a monitoring processing.

If, for example, an item of Keep linked to the item of Try is not input and a new item of Try linked to the item of Try is input, the first monitoring unit starts the processing for determining whether it is monitoring timing and continues the monitoring processing. If an item of Keep linked to the item of Try is not input and a new item of Try linked to the item of Try is not input, the first monitoring unit outputs a monitoring result according to a method of outputting the monitoring result to be described later.

If the monitoring result indicating that information about an item of Keep is not input and that an item of Try has not been input for a predetermined time is acquired or that an item of Keep has not been input for a predetermined time is acquired, the higher person selector selects a higher responsible person governing the responsible persons in charge of the respective projects related to the monitoring result from the higher person storage unit.

Furthermore, if an item of Try is not input when the information search device notified the responsible person “Ichiro” of the systematic problem, for example, the information search device according to the second embodiment selects “Hanako” who is the higher responsible person governing the responsible person “Ichiro” from the higher person storage unit.

The first monitoring result output unit outputs the monitoring result acquired by the first monitoring unit from the retrospect database 301, the display 102 or the communication unit 103. The second monitoring result output unit outputs the monitoring result acquired by the second monitoring unit from the retrospect database 301, the display 102 or the communication unit 103. For example, each of the first monitoring result output unit and the second monitoring result output unit outputs the monitoring result using the information about the selected higher responsible person. As another detailed example, if “Hanako” who is the higher responsible person governing the responsible person “Ichiro” is selected from the higher person storage unit, each of the first monitoring result output unit and the second monitoring result output unit notifies “Hanako” of the monitoring result via the communication unit 103.

As still another detailed example, if an item of Try linked to the search result is input as shown in FIG. 19, the first monitoring result output unit or the second monitoring result output unit inputs the input item of Try to the retrospect database 301. Specifically, in the example shown in FIG. 19, if an item of Try “Chief holds hearing with Chief of A Development Department” linked to the search result linked to the systematic problem “YES” is input, the first monitoring result output unit or the second monitoring result output unit inputs the item of Try to the retrospect database 301. For example, the first monitoring result output unit or the second monitoring result output unit stores a type “Try”, a link “P3→T3”, a title “escalation”, an explanation “Chief holds hearing with Chief of A Development Department”, and a date of generation “2007/1/15” in the retrospect database 301 while making them correspond to an ID “T3”.

If the input item of Try is not moved to items of Keep a predetermined number of times or more, the first monitoring result output unit or the second monitoring result output unit may notify the higher person governing the responsible persons in charge of the respective projects that the input item of Try is not moved to items of Keep a predetermined number of times or more.

### [Monitoring Processing Performed by Information Search Device According to the Second Embodiment]

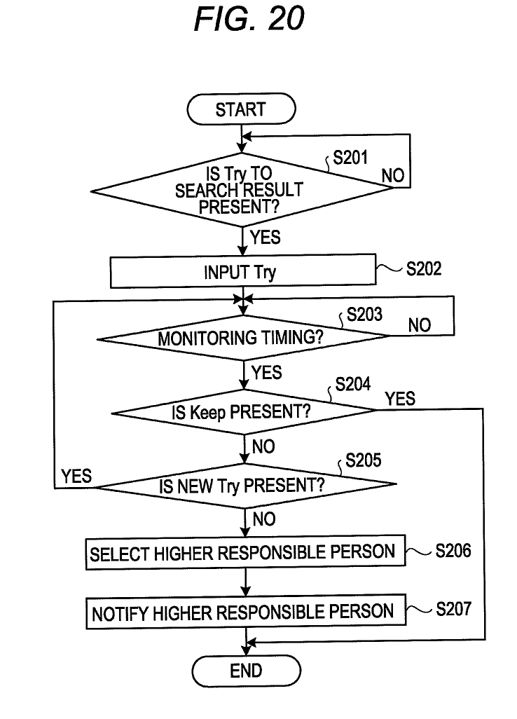

Next, referring to FIG. 20, a processing related to measures against a systematic problem according to the second embodiment will be described. FIG. 20 is a flowchart showing the processing related to the measures against the systematic problem according to the second embodiment.

As shown in FIG. 20, the first monitoring unit monitors whether an item of Try linked to the search result is input (step S201). If an item of Try linked to the search result is input (step S201; Yes), the first monitoring result output unit inputs the input item of Try to the retrospect database 301 (step S202). Thereafter, the first monitoring unit determines whether it is monitoring timing (step S203). If it is not monitoring timing (step S203; No), the first monitoring unit continues to determine whether it is monitoring timing until the monitoring timing comes.

If it is monitoring timing (step S203; Yes), the first monitoring unit monitors whether an item of Keep linked to the item of Try (that is, an item of Keep linked to an item of Problem to which the item of Try is linked) is input (step S204). Further, the first monitoring unit monitors whether a new item of Try linked to the item of Try (that is, an item of Try linked to the item of Problem to which the former item of Try is linked) is input (step S205). If an item of Keep linked to the item of Try is input (step S204; Yes), the first monitoring unit finishes the monitoring processing.

If an item of Keep linked to the item of Try is not input (step S204; No) and a new item of Try linked to the item of Try is input (step S205; Yes), the first monitoring unit restarts the monitoring processing for determining whether it is monitoring timing (step S203) and subsequently continues the monitoring processing (steps S203 to S205). If an item of Keep linked to the item of Try is not input (step S204; No) and a new item of Try linked to the item of Try is not input (step S205; No), the higher person selector selects a higher responsible person (step S206). Thereafter, the first monitoring result output unit notifies the higher responsible person of the monitoring result (step S207) and finishes the monitoring processing.

### Advantage of the Second Embodiment

As stated above, according to the second embodiment, the situation of taking a measure against the systematic problem can be easily grasped.

Specifically, according to the second embodiment, the information search device monitors whether a trial improvement plan is taken against a systematic problem against which a stored improvement plan is not taken and outputs a monitoring result. It is possible to easily grasp a systematic problem against which a trial improvement plan is taken and a systematic problem against which a trial improvement plan is not taken as compared with the method that does not include monitoring a situation of taking a measure against the systematic problem.

According to the second embodiment, the situation of taking the measure against the systematic problem can be easily grasped.

Specifically, as compared with the method of not monitoring a situation of taking a measure against a systematic problem, the information search device according to the second embodiment monitors whether a predetermined time passes improvement plan has not been input and stored, and then outputs a monitoring result. It is thereby possible to easily grasp the systematic problem unlinked to the stored improvement plan.

Moreover according to the second embodiment if no measure is taken against the systematic problem, the higher responsible person can easily grasp the systematic problem. By allowing the higher responsible person to grasp the systematic problem, the higher responsible person can urge the responsible persons to take improvement plans against the problem.

Specifically, as compared with the method of not notifying the higher responsible person governing the responsible persons related to the systematic problem, the information search device according to the second embodiment notifies the higher responsible person governing the responsible persons that a trial improvement plan against the systematic problem has not been input to the retrospect database for a predetermined time (no measures are taken against the systematic problem) if the trial improvement plan against the systematic problem has not been input to the retrospect database for the predetermined time. The higher responsible person can thereby urge the responsible persons to take an appropriate measure against the systematic problem. Further, the higher responsible person can easily grasp the presence of the systematic problem necessary to deal with.

### Third Embodiment

The information search devices according to the first and second embodiment have been described so far. However, the present invention can be carried out in various different modes from the first and second embodiments. Therefore, an information search device according to a third embodiment of the present invention will be described as a different embodiment from the first and second embodiment.

### (1) Search Timing

In the first and second embodiments, the time of receiving a search command from the operation unit 101 is the time of starting an information search. However, the present invention is not limited to this example. A search processing may be started at an arbitrary time, as well. For example, a search processing may be performed at regular intervals (e.g., one week's intervals or 24 hours' intervals).

### (2) Responsible Person

In the first embodiment, for example, the case in which the information search device includes the personnel information database and the method of notifying the responsible persons of the systematic problem have been described. However, the present invention is not limited to that example and method. The information search device does not necessarily include the personnel information database and it is not always necessary to notify the responsible persons of the systematic problem.

### (3) System Configuration and Others

Processing procedures, control procedures, specific names, information including various pieces of data and parameters described in the specification and shown in the drawings (e.g., FIGS. 1A to 21) can be arbitrarily changed unless specified otherwise.

Moreover, the constituent elements of each of the devices shown in the drawings are functionally conceptual and are not necessarily physical elements. That is, specific modes for distribution and integration of each of the devices are not limited to the modes shown in the drawings. All of or part of the constituent elements can be configured to be functionally or physically distributed or integrated according to various loads, utilization status, and the like. (For example, in FIG. 2, the systematic problem candidate search unit 402 and the systematic problem search unit 403 may be integrated and the storage unit 300 may be separated from the information search device 100.)

### (4) Program for Information Search Device (Information Search Program)

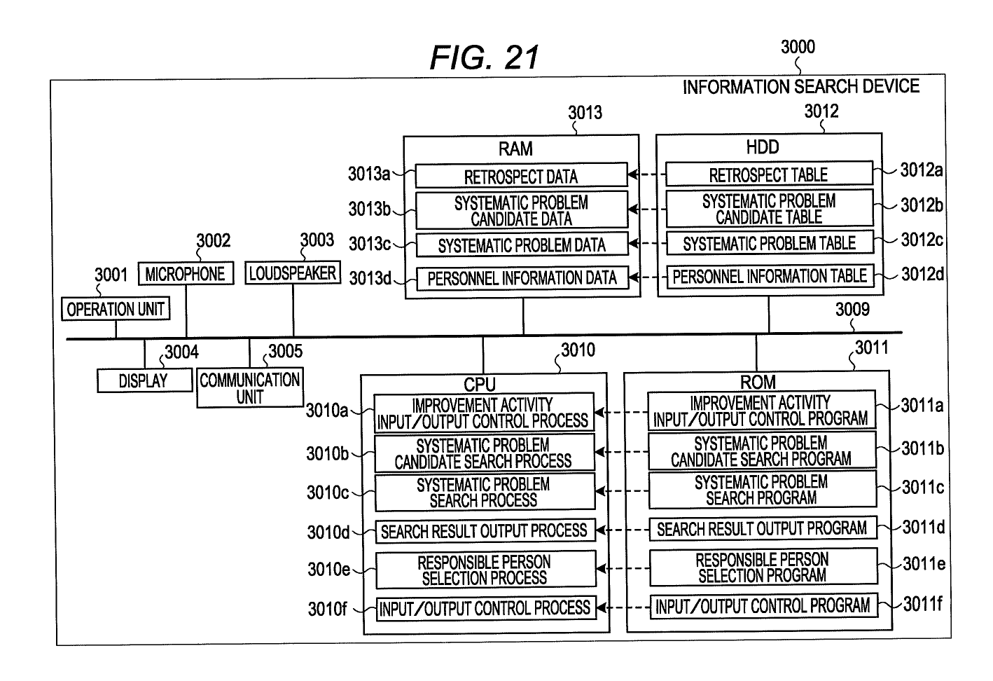

Meanwhile, in the first embodiment, realizing various processings by hardware logic has been described. However, the present invention is not limited to this example. Alternatively, various processings may be realized by causing a computer to execute a program prepared in advance. Therefore, an example of a computer executing an information search program including the same functions as those of the information search device according to the first embodiment will be described with reference to FIG. 21. FIG. 21 is a block diagram showing programs of the information search device according to the first embodiment.

As shown in FIG. 21, an information search device 3000 according to the third embodiment is configured to connect an operation unit 3001, a microphone 3002, a loudspeaker 3003, a display 3004, a communication unit 3005, a CPU 3010, a ROM 3011, a HDD 3012, and a PAM 3013 to one another by a bus 3009 or the like.

The ROM 3011 stores therein control programs exhibiting the same functions as the improvement activity input/output control unit 401, the systematic problem candidate search unit 402, the systematic problem search unit 403, the search result output unit 404, the responsible person selector 405, and the input/output control I/F unit 200 shown in the first embodiment in advance. Namely, as shown in FIG. 21, the ROM 3011 stores therein an improvement activity input/output control program 3011a, a systematic problem candidate search program 3011b, a systematic problem search program 3011c, a search result output program 3011d, a responsible person selection program 3011e, and an input/output control program 3011f in advance. Similar to the constituent elements of the information search device shown in FIG. 2, these programs 3011a to 3011f may be appropriately integrated or distributed.

The CPU 3010 reads these programs 3011a to 3011f from the ROM 3011 and executes the programs 3011a to 3011f. By doing so, as shown in FIG. 21, the programs 3011a to 3011f function as an improvement activity input/output control process 3010a, a systematic problem candidate search process 3010b, a systematic problem search process 3010c, a search result output process 3010d, a responsible person selection process 3010e, and an input/output control process 3010f, respectively. It is to be noted that the processes 3010a to 3010f correspond to the improvement activity input/output control unit 401, the systematic problem candidate search unit 402, the systematic problem search unit 403, the search result output unit 404, the responsible person selector 405, and the input/output control I/F unit 200, respectively.

The HDD 3012 includes a retrospect table 3012a, a systematic problem candidate table 3012b, a systematic problem table 3012c, and a personnel information table 3012d. The retrospect table 3012a corresponds to the retrospect database 301. The systematic problem candidate table 3012b corresponds to the systematic problem candidate database 302. The systematic problem table 3012c corresponds to the systematic problem database 303. The personnel information table 3012d corresponds to the personnel information database 304.

The CPU 3010 reads the retrospect table 3012a, the systematic problem candidate table 3012b, the systematic problem table 3012c, and the personnel information table 3012d from the HDD 3012, stores the read tables 3012a to 3012d in the RAM 3013, and executes the information search program using retrospect data 3013a, systematic problem candidate data 3013b, systematic problem data 3013c, and personnel information data 3013d.

The programs 3011a to 3011f described in the third embodiment are not necessarily stored in the ROM 3011 in advance. For example, the programs 3011a to 3011f may be stored in, for example, a “portable physical medium” such as a memory card, a flexible disk, a CD-ROM, an MO disk, a DVD disk, a magneto optical disk or an IC card inserted into an information search device, a “fixed physical medium” such as an external HDD provided externally of the information search device or an internal HDD provided internally thereof, or “another computer (or server)” connected to the information search device via a public line, the Internet, LAN, WAN or the like, and the information search device may read these programs 3011a to 3011f from one of the mediums and another computer (or server) and execute the programs 3011a to 3011f.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer readable recording medium storing an information search program executed by a computer, the program searching information about projects, the program comprising:
a systematic problem search procedure searching information about a systematic problem from a retrospect storage unit, the systematic problem being a common problem to a plurality of the projects, using a conditional expression for searching the information about the systematic problem based on one of or a plurality of a count by which the information about the systematic problem is stored in the retrospect storage unit, a count by which a trial improvement plan linked to the systematic problem is stored in the retrospect storage unit, and information indicating whether the stored improvement plan is stored in the retrospect storage unit, as a conditional expression indicating a condition for extracting the information about the systematic problem; and
a systematic problem output procedure outputting a search result in the systematic problem search procedure to each of or one of a predetermined storage unit and a predetermined output unit.

2. The computer readable recording medium according to claim 1,
wherein in the systematic problem search procedure, the information about the systematic problem is searched from the retrospect storage unit while narrowing down the information about the systematic problem for each of a plurality of different conditional expressions by using the plurality of different conditional expressions as the conditional expression.

3. The computer readable recording medium according to claim 2, further comprising:
a responsible person selection procedure selecting information about a responsible person in charge of one of the projects related to the search result in the systematic problem search procedure from a responsible person storage unit storing therein information about responsible persons in charge of the plurality of projects for the plurality of projects, respectively,
wherein in the systematic problem output procedure, the search result is output using the information about the responsible person selected in the responsible person selection procedure.

4. The computer readable recording medium according to claim 3, further comprising:
a first monitoring procedure monitoring whether the information about the stored improvement plan linked to the information about the systematic problem is not input to the retrospect storage unit and whether the information about the trial improvement plan linked to the information about the systematic problem has not been input to the retrospect storage unit for a predetermined time if the information about the systematic problem is searched in the systematic problem search procedure; and
a first monitoring result output procedure outputting a monitoring result in the first monitoring procedure to each of or one of the predetermined storage unit and the predetermined output unit.

5. The computer recording medium according to claim 4, further comprising:
a second monitoring procedure monitoring whether the information about the stored improvement plan linked to the information about the systematic problem has not been input to the retrospect storage unit for a predetermined time if the information about the systematic problem is searched in the systematic problem search procedure; and
a second monitoring result output procedure outputting a monitoring result in the second monitoring procedure to each of or one of the predetermined storage unit and the predetermined output unit.

6. The computer readable recording medium according to claim 5, further comprising:
a higher person selection procedure selecting a higher responsible person governing the responsible person in charge of one of the projects related to the first monitoring result or the second monitoring result from a higher person storage unit that is a storage unit storing therein information about higher responsible persons governing the responsible persons in charge of the plurality of projects, respectively if the first monitoring result indicating that the information about the stored improvement plan is not input and that the information about the trial improvement plan has not been input for the predetermined time is obtained in the first monitoring procedure or if the second monitoring result indicating that the information about the stored improvement plan has not been input for the predetermined time is obtained in the second monitoring procedure,
wherein in the first monitoring result output procedure or the second monitoring result output procedure, the first monitoring result or the second monitoring result is output using the information about the higher responsible person selected in the higher person selection procedure.

7. An information search method searching information about projects, the method comprising:
a systematic problem search operation searching information about a systematic problem from a retrospect storage unit, the systematic problem being a common problem to the plurality of projects, using a conditional expression for searching the information about the systematic problem based on one of or a plurality of a count by which the information about the systematic problem is stored in the retrospect storage unit, a count by which a trial improvement plan linked to the systematic problem is stored in the retrospect storage unit, and information indicating whether the stored improvement plan is stored in the retrospect storage unit, as a conditional expression indicating a condition for extracting the information about the systematic problem; and
a systematic problem output operation outputting a search result at the systematic problem search operation to each of or one of a predetermined storage unit and a predetermined output unit.

8. The method according to claim 7,
wherein at the systematic problem search operation, the information about the systematic problem is searched from the retrospect storage unit while narrowing down the information about the systematic problem for each of a plurality of different conditional expressions by using the plurality of different conditional expressions as the conditional expression.

9. The method according to claim 7, further comprising:
a responsible person selection operation selecting information about a responsible person in charge of one of the projects related to the search result in the systematic problem search procedure from a responsible person storage unit storing therein information about responsible persons in charge of the plurality of projects for the plurality of projects, respectively,
wherein at the systematic problem output operation, the search result is output using the information about the responsible person selected at the responsible person selection operation.

10. The method according to claim 7, further comprising:
a first monitoring operation monitoring whether the information about the stored improvement plan linked to the information about the systematic problem is not input to the retrospect storage unit and whether the information about the trial improvement plan linked to the information about the systematic problem has not been input to the predetermined retrospect storage unit for a predetermined time if the information about the systematic problem is searched at the systematic problem search operation; and
a first monitoring result output operation outputting a monitoring result at the first monitoring operation to each of or one of the predetermined storage unit and the predetermined output unit.

11. The method according to claim 10, further comprising:
a second monitoring operation monitoring whether the information about the stored improvement plan linked to the information about the systematic problem has not been input to the retrospect storage unit for a predetermined time if the information about the systematic problem is searched at the systematic problem search operation; and
a second monitoring result output operation outputting a monitoring result at the second monitoring operation to each of or one of the predetermined storage unit and the predetermined output unit.

12. The method according to claim 11, further comprising:
a higher person selection operation selecting a higher responsible person governing the responsible person in charge of one of the projects related to the first monitoring result or the second monitoring result from a higher person storage unit that is a storage unit storing therein information about higher responsible persons governing the responsible persons in charge of the plurality of projects, respectively if the first monitoring result indicating that the information about the stored improvement plan is not input and that the information about the trial improvement plan has not been input for the predetermined time is obtained at the first monitoring operation or if the second monitoring result indicating that the information about the stored improvement plan has not been input for the predetermined time is obtained at the second monitoring operation,
wherein at the first monitoring result output operation or the second monitoring result output operation, the first monitoring result or the second monitoring result is output using the information about the higher responsible person selected at the higher person selection operation.

13. An information search device for searching information about projects, the information search device comprising:
a retrospect storage unit, the retrospect storage unit being a storage unit storing therein information about a problem of each of the plurality of projects whenever the information about the problem of each of the plurality of projects is input, information about a trial improvement plan that is an improvement plan against the problem of each of the plurality of projects whenever the information about the trial improvement plan is input, and information about a stored improvement plan that is an effective trial improvement plan against the problem of each of the plurality of projects whenever the information about the stored improvement plan is input, and storing therein the information about the trial improvement plan and the information about the stored improvement plan while linking the information about the trial improvement plan and the information about the stored improvement plan to the information about the systematic problem for each of the plurality of projects;
a systematic problem search unit searching information about a systematic problem from the retrospect storage unit, the systematic problem being a common problem to the plurality of projects, using a conditional expression for searching the information about the systematic problem based on one of or a plurality of a count by which the information about the systematic problem is stored in the retrospect storage unit, a count by which the trial improvement plan linked to the systematic problem is stored in the retrospect storage unit, and information indicating whether the stored improvement plan is stored in the retrospect storage unit, as a conditional expression indicating a condition for extracting the information about the systematic problem; and
a systematic problem output unit outputting a search result obtained by the systematic problem search unit to each of or one of a predetermined storage unit and a predetermined output unit.

14. The information search device according to claim 13,
wherein the systematic problem search unit searches the information about the systematic problem from the retrospect storage unit while narrowing down the information about the systematic problem for each of a plurality of different conditional expressions by using the plurality of different conditional expressions as the conditional expression.

15. The information search device according to claim 14, further comprising:
a responsible person storage unit storing therein information about responsible persons in charge of the plurality of projects for the plurality of projects, respectively; and
a responsible person selection unit selecting information about a responsible person in charge of one of the projects related to the search result in the systematic problem search procedure from the responsible person storage unit,
wherein the systematic problem output unit outputs the search result using the information about the responsible person selected by the responsible person selection unit.

16. The information search device according to claim 15, further comprising:
a first monitoring unit monitoring whether the information about the stored improvement plan linked to the information about the systematic problem is not input to the retrospect storage unit and whether the information about the trial improvement plan linked to the information about the systematic problem has not been input to the retrospect storage unit for a predetermined time if the information about the systematic problem is searched by the systematic problem search unit; and
a first monitoring result output unit outputting a monitoring result obtained by the first monitoring unit to each of or one of the predetermined storage unit and the predetermined output unit.

17. The information search device according to claim 16, further comprising:
a second monitoring unit monitoring whether the information about the stored improvement plan linked to the information about the systematic problem has not been input to the retrospect storage unit for a predetermined time if the information about the systematic problem is searched by the systematic problem search unit; and
a second monitoring result output unit outputting a monitoring result obtained by the second monitoring unit to each of or one of the predetermined storage unit and the predetermined output unit.

18. The information search device according to claim 17, further comprising:
a higher person storage unit that is a storage unit storing therein information about higher responsible persons governing the responsible persons in charge of the plurality of projects, respectively; and
a higher person selection unit selecting a higher responsible person governing the responsible person in charge of one of the projects related to the first monitoring result or the second monitoring result from the higher person storage unit if the first monitoring result indicating that the information about the stored improvement plan is not input and that the information about the trial improvement plan has not been input for the predetermined time is obtained by the first monitoring unit or if the second monitoring result indicating that the information about the stored improvement plan has not been input for the predetermined time is obtained by the second monitoring unit,
wherein the first monitoring result output unit or the second monitoring result output unit outputs the first monitoring result or the second monitoring result using the information about the higher responsible person selected by the higher person selection unit.
